(19) United States
(12) Patent Application Publication
(10) Pub. No.: US 2016/0202776 A1
(43) Pub. Date: Jul. 14, 2016

(54) NOVEL PASSIVE STYLUS

(71) Applicant: Intel Corporation, Santa Clara, CA (US)

(72) Inventors: Raghvendra Maloo, Bangalore (IN); John Valavi, Beaverton, OR (US); Shwetank Kumar, San Francisco, CA (US); Arvind S., Bangalore (IN)

(21) Appl. No.: 14/866,833

(22) Filed: Sep. 25, 2015

(30) Foreign Application Priority Data
Jan. 14, 2015 (IN) 228/CHE/2015

(51) Int. Cl. G06F 3/0354; G06F 3/041; G06F 3/044

(52) U.S. Cl. CPC G06F 3/03545; G06F 3/044; G06F 3/0412; G06F 3/0416

(57) ABSTRACT

The present disclosure pertains to stylus' for electronic devices, and in particular, to passive stylus' with multi-faceted functionality. A passive stylus has a first end and a second end wherein at the first end, a first nib is present, and at the second end, a second nib is present. The passive stylus may be suited to effect communication with a touch-input device adaptable to receive input from both ends of the stylus. The touch-input device contains code, when executed, to cause the device to initialize a touch application, receive an indication of touch data, identify a tip pattern from the received touch data, and execute a set of pre-determined instructions associated with the identified tip pattern. Furthermore, the touch-input device includes aprocessing unit communicatively coupled to memory. The memory includes code to identify a tip pattern from a set of known tip patterns associated with touch data.

### CROSS-REFERENCE TO RELATED APPLICATIONS

This application claims priority to Indian Patent Application No. 228/CHE/2015, titled “A NOVEL PASSIVE STYLUS”, filed Jan. 14, 2015, which is hereby incorporated by reference in its entirety.

### FIELD

The present disclosure pertains to stylus' for electronic devices, and in particular, to passive stylus' with multi-faceted functionality.

### SUMMARY

A passive stylus consistent with the present disclosure includes a shaft having a first end and a second end. A first nib is present at the first end and a second nib at the second end. In various implementations, the first nib and the second nib are unique. A passive stylus consistent with the present disclosure may be suited to effect communication with a touch-input device adaptable to receive input from both ends.

A touch-input device consistent with the present disclosure may contain code, when executed, to cause the device to initialize a touch application, receive an indication of touch data, identify a tip pattern from the received touch data, and execute a set of pre-determined instructions associated with the identified tip pattern. Furthermore, the touch-input device may be associated with a host-side processing unit communicatively coupled to memory. The memory includes code to identify a tip pattern from a set of known tip patterns associated with touch data.

### BRIEF DESCRIPTION OF THE DRAWINGS

To facilitate understanding, identical reference numerals have been used, where possible, to designate identical elements that are common to the drawings. The drawings are not to scale and the relative dimensions of various elements in the drawings are depicted schematically and not necessarily to scale. The techniques of the present disclosure may readily be understood by considering the following detailed description in conjunction with the accompanying drawings, in which:

FIG. 1 is an exploded view of a multi-barrel passive stylus consistent with the present disclosure.

FIG. 2 is a dual-nibbed passive stylus which can form a sharp-tip capacitive image on a touch-input device.

FIG. 3 is a dual-nibbed passive stylus which can form a dull-tip capacitive image on a touch-input device.

FIG. 4 is a dual-nibbed passive stylus which can form a flattened-tip capacitive image on a touch-input device.

FIG. 5 is an illustration of one end of a passive stylus in contact with a surface of a touchscreen component of a touch-input device.

FIG. 6 is an illustration of another end of the passive stylus shown in FIG. 5 which is contact with a surface of a touchscreen component of a touch-input device.

FIG. 7 is a touch processing pipeline consistent with the present disclosure.

FIG. 8 is an exemplary layout of a computer architecture of a touch-input device operable to process touch-screen inputs consistent with the present disclosure.

FIG. 9 is yet another exemplary layout of a computer architecture which is operable to process touch-screen inputs with a passive stylus consistent with the present disclosure.

FIG. 10 is an illustration of the distribution of touch data processed by proprietary and vendor kernels within the touch processing pipeline.

FIG. 11 is a flowchart of a method of processing touch data consistent with an embodiment of the present disclosure.

### DETAILED DESCRIPTION

A detailed description of some embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to some embodiments have not been described in detail to avoid unnecessarily obscuring the description.

In this disclosure, a passive stylus may be defined as a capacitive stylus or digitizer pen which may be used to induce touch data on a touch-input device. Touch data may consist of a blob created when the passive stylus makes contact with a touchscreen surface of a touch-input device. A passive stylus may be used for various applications, such as but not limited to, navigation, note taking, drawing, and other precision-based applications. In the present disclosure, a passive stylus may be used to effect various commands or instantiate various operation modes of a host device (e.g., touch-input device).

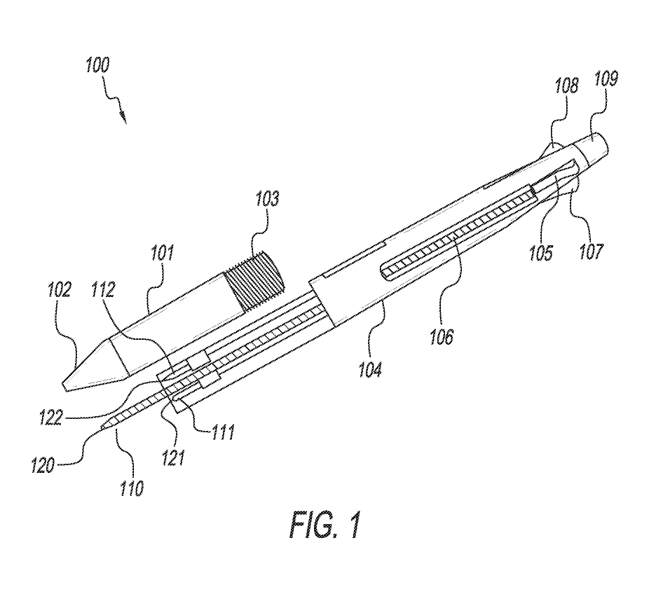

FIG. 1 is an exploded view of a multi-barrel passive stylus 100 consistent with the present disclosure. Multi-barrel passive stylus 100 includes shaft components 101, 104 which may allow a user to disassemble the stylus 100 to perform maintenance, cleaning, etcetera. In some embodiments, shaft component 101 may have a threaded portion 103 which allows the shaft component 101 to mate with a complementary thread portion (not shown) of shaft component 104. It should be understood by one having ordinary skill in the art that the present disclosure is not limited thereto but may be adaptable to other coupling mechanisms and techniques known in the art. Additionally, shaft component 101 includes a barrel opening 102 through which nib components extend there through when the stylus 100 is in operation.

Shaft component 104 includes a shaft 106 where a plurality of rods 110, 111, 112 are disposed there through. Shaft 106 has a first end and a second end. At the first end, the nibs 120, 121, 122 of rods 110, 111, 112 are exposed whereas at the second end, yet another nib 109 is disposed. As will be described in more detail below, each rod 110, 111, 112 has a unique nib shape such that various tip patterns and capacitive images may be created on a touch-input device when the multi-barrel passive stylus 100 is in operation. For example, rod 110 has a rectangular-shaped nib 120, rod 121 has a round-shaped nib 121, and rod 122 has a pointed-shaped nib 122. In yet other embodiments, some of the rods have the same nib shape to serve as backup.

Because multi-barrel passive stylus 100 has three rods 110, 111, 112, with nibs 120, 121, 122, stylus 100 can effect three unique capacitive images on a touch-input device. Advantageously, because each nib can create a unique capacitive image, the present disclosure provides a manner for a user to initiate various commands. For example, nib 120 may initiate a drawing command, nib 121 may initiate a selecting command, whereas nib 122 may initiate an erasing command. However, the present disclosure is not limited to three rods or three nibs and may be adapted to include more or less (minimum of two nibs) and this would be consistent with the spirit of the present disclosure. Furthermore, multi-barrel passive stylus 100 is not limited to rods with nibs housed within the shaft 106 and may include a nib coupled to an external region of the stylus 100 (as shown by nib 109).

To employ a particular nib, multi-barrel passive stylus 100 may include mechanical push-down sliders 105, 107, 108 coupled to an opposite end of the rods 110, 111, 112. In some implementations, the mechanical push-down sliders 105, 107, 108 may expose the rods, one at a time, beyond the second end of the shaft 106 to make contact and form a distinctive capacitive image on a touch-input device.

A passive stylus 100 may also incorporate a spring component (not shown) such that the mechanical push-down sliders 105, 107, 108 are spring loaded. A passive stylus described herein may also have other mechanical components known in the art.

Most notably, a passive stylus described within this disclosure is electronic-circuitry free which reduces the size requirements of the stylus device and its cost to manufacture. Accordingly, a passive stylus device disclosed herein is not dependent on power requirements—battery and charging circuitry and is therefore always available. Furthermore, a passive stylus device consistent with the present disclosure is not dependent on electromagnetic frequency bandwidths and hence can support many touch-input/sensitive devices.

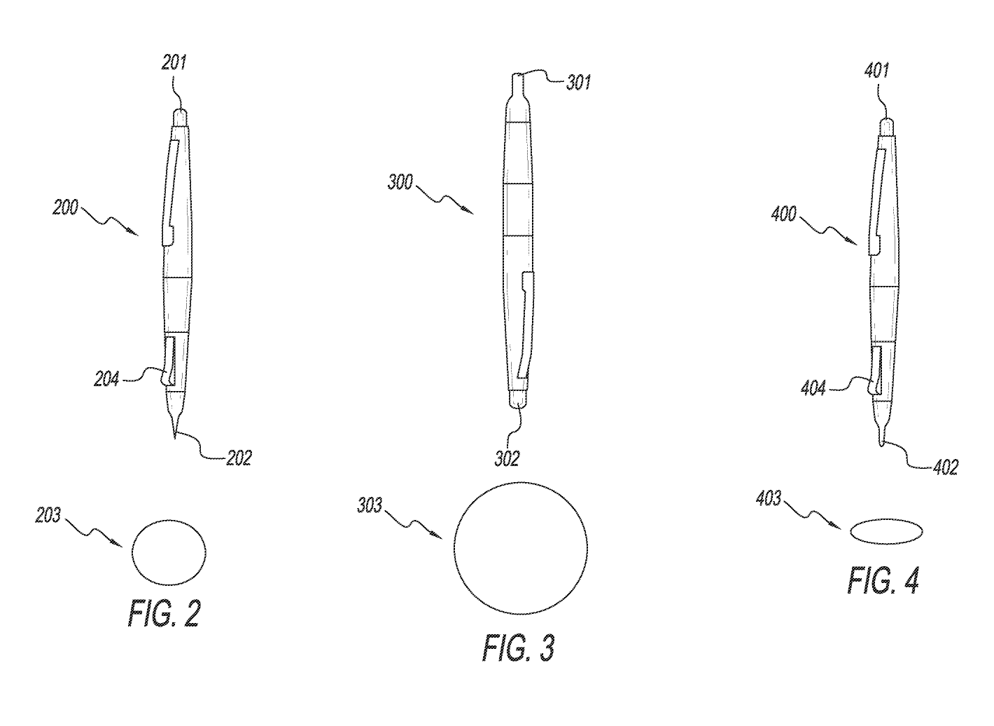

FIG. 2 is a dual-nibbed passive stylus 200 which can form a sharp-tip capacitive image on a touch-input device. Dual-nibbed passive stylus 200 includes a first end and a second end. The first end includes a first nib 201 and the second end includes a second nib 202. First and second nibs 201, 202 are unique because they have different shapes and can create unique tip patterns and capacitive images on a touch-input device (e.g., touchscreen portion thereof).

In the embodiment shown in the figure, first nib 201 has a greater contact area than the contact area of nib 202. Accordingly, a user can use both ends of dual-nibbed passive stylus 200 to effect at least two commands or modes. Specifically, first nib 201 has a rectangular or square shape. However, second nib 202 may have a pointed shape. Further, dual-nibbed passive stylus 200 may include a lever 204 to expose or conceal the second nib 202.

Because first nib 201 and second nib 202 have unique shapes, nibs 201, 202 will form unique tip patterns and capacitive images. An exemplary illustration of a capacitive image 203 attributable to second nib 202 is further shown in the figure.

FIG. 3 is another dual-nibbed passive stylus 300 which can form a dull-tip capacitive image on a touch-input device. Dual-nibbed passive stylus 300 includes a first nib 301 and a second nib 302. In particular, second nib 302 can be used to form a different capacitive image than that of dual-nibbed passive stylus 200 shown in FIG. 2. In some implementations, first nib 301 may be used to effect a first computing mode in a touch-input device whereas second nib 302 may be used to effect a second computing mode. Notably, second nib 302 has a relative flat shape such that is creates a different unique tip pattern than nib 202 shown in FIG. 2.

FIG. 4 is yet another dual-nibbed passive stylus 400 which can form a flattened-tip capacitive image on a touch-input device. Dual-nibbed passive stylus 400 includes a first nib 401, second nib 402, and lever 404. Notably, dual-nibbed passive stylus 400 includes a nib 402 with a shape that is distinguishable from nib 202 (FIG. 2) and nib 301 (FIG. 3) which is illustrated by an exemplary capacitive image 403 formed by nib 402.

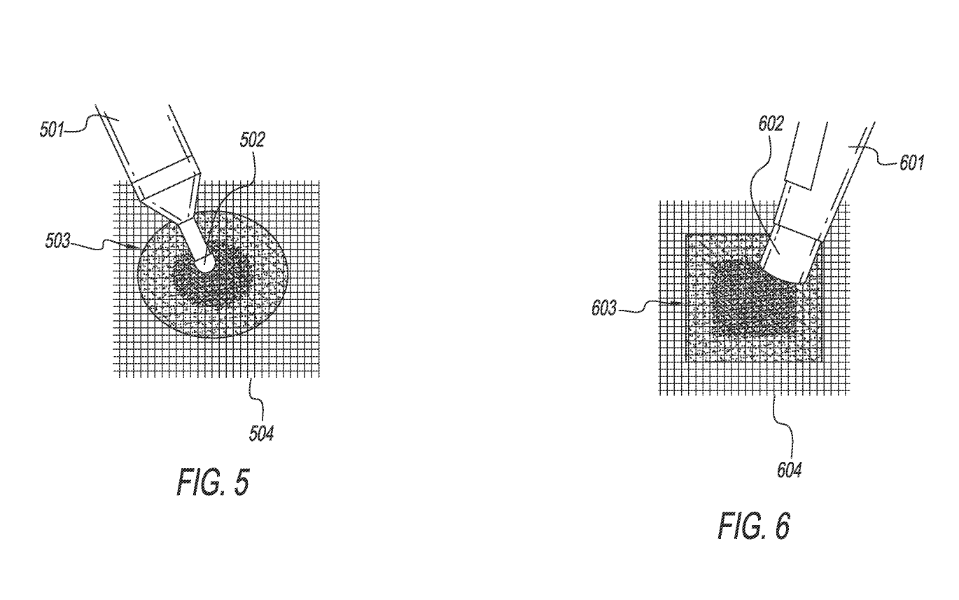

FIG. 5 is an illustration of one end of a passive stylus 501 in contact with the surface of the touchscreen 504 of a touch-input device (not shown). Particularly, a nib 502 portion of the passive stylus 501 is in contact with the surface of the touchscreen 504 creating a capacitive image 503 due to the tip pattern induced onto the surface of the touchscreen 504.

FIG. 6 is an illustration of another end of the passive stylus of FIG. 5 in contact with a surface of the touchscreen 604 of a touch-input device (not shown). In particular, nib 602 of passive stylus 601 is in contact with the surface of the touchscreen 604 creating a capacitive image 603 due to the tip pattern induced onto the surface of the touchscreen 604. Notably, the pattern of capacitive image 603 is different than that of capacitive image 503 (FIG. 5). In some implementations, when the nib 602 portion of passive stylus 601 contacts the touchscreen 604 (e.g., by manual user intervention), a command is generated for a touch-input device to switch to a specific computing mode or carry out a specific function.

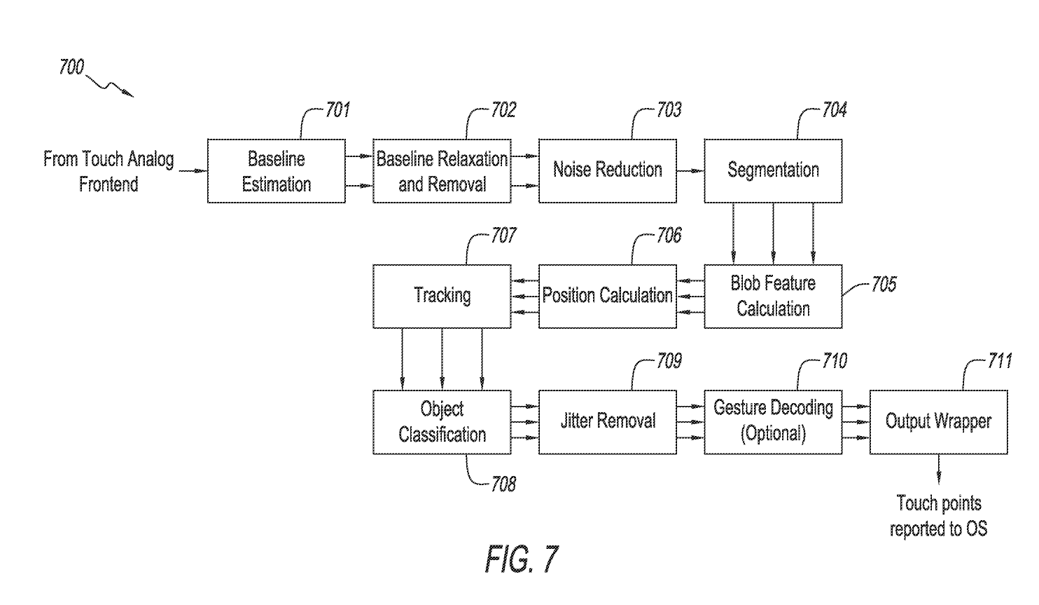

FIG. 7 is a touch processing pipeline 700 consistent with the present disclosure. In the embodiment shown, touch processing pipeline 700 may receive raw touch data from an analog frontend circuitry. However, the present disclosure is not limited thereto. As such, analog frontend circuitry may be coupled to a touch array of a touch-input device to directly provide raw touch data to a Platform Controller Hub (PCH) of a touch-input device.

Raw touch data may be received at baseline estimation block 701 where the data is further processed as illustrated by baseline relaxation and removal block 702, noise reduction block 703, segmentation block 704, blob feature calculation block 705, position calculation block 706, tracking block 707, object classification block 708, jitter removal block 709, gesture decoding (optional) block 710, and output wrapper block 711. After the touch data is processed within the touch processing pipeline 700, touch points are reported to an operating system. In some embodiments, the touch points are reported to the operating system in the form of a message which includes an identified tip pattern (or description thereof) and a command to execute a set of pre-determined instructions associated with the identified tip pattern.

Most notably, the present disclosure improves upon prior art touch processing pipeline by enhancing the functionality of object classification block 708. In the present disclosure, objection classification block 708 determines the tip pattern of the received raw touch data and in some embodiments, the determining includes measuring a feature set of the tip pattern such as, but not limited to, a maximum pixel value, measuring a blob area of the tip pattern, and measuring a maximum slope of the blob. Moreover, the detected tip pattern may be accentuated using temporal signals to further add to the robustness of the tip-pattern detection technique described herein. It should be appreciated by one having ordinary skill in the art that the aforementioned feature sets are more a function of the passive stylus' nib rather than the manner of which the stylus is held or maneuvered by a user.

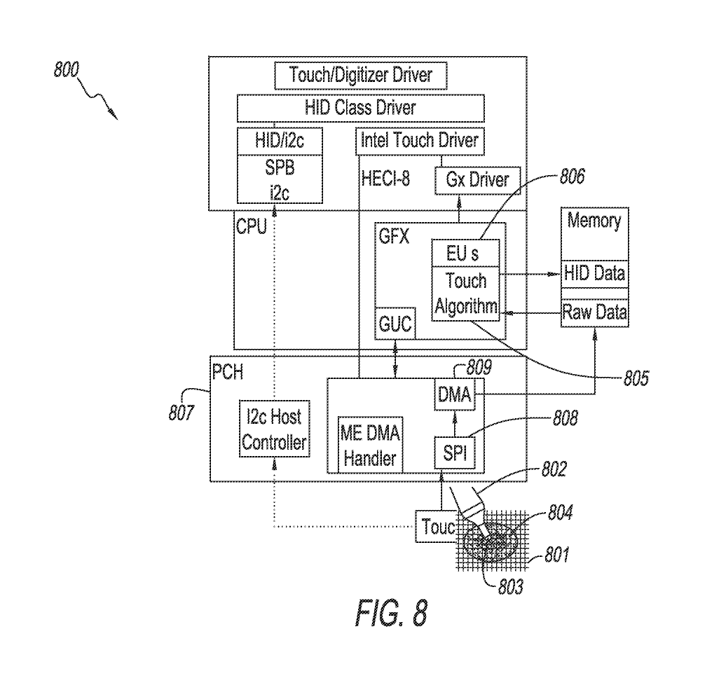

FIG. 8 is an exemplary layout of a computer architecture 800 of a touch-input device operable to process touch-screen inputs consistent with the present disclosure. The touch-input device may include any device which has electronic circuitry and necessary software to receive raw touch data and translate said data to specific command request(s). A touch-input device may be any of a smartphone, computing tablet, notebook computer, sub-notebook computer, ultraportable notebook computer, mini-notebook computer, netbook computer, ultrabook computer, or laptop computer but is not limited to these.

A touch-input device consistent with the present disclosure may be associated with a host-side processing unit communicatively coupled to memory. In other embodiments, the touch-input device may be associated with standalone touch device and therefore may include a processing unit therein. In some embodiments, the memory includes code to identify a tip pattern from a set of known tip patterns associated with touch data. In some implementations, the processing unit includes a central processing unit whereas in other implementations, the processing unit includes a graphics processing unit. The memory component of the touch-input device includes code to execute a set of pre-determined instructions associated with the identified tip pattern. However, the present disclosure is not limited thereto. Further, a touch-input device consistent with the present disclosure includes a touch ASIC and/or integrated sensor hub that is operable to receive an indication of the touch data. Moreover, because the passive devices disclosed herein are electronic-circuitry free, a hardware sensor (e.g., EMR sheet) is not required on the touch-input device thereby conserving cost, power, and space.

In the embodiment shown in the figure, computer architecture 800 includes Intel's® Integrated Touch technology but the he present disclosure is not limited thereto. As such, computer architecture 800 includes an Intel® kernel which helps process the touch data as will be described below.

As shown in the figure, a passive stylus 802 having a round tip 803 can create a capacitive image 804 on a touch sensor 801 of a touch-input device. Additionally, analog circuitry may be coupled to a touch array of a touch-input device to directly provide touch data to Platform Controller Hub (PCH) 807. In the embodiment shown, touch sensor 801 may be coupled to PCH 807 via a serial peripheral interface (SPI). However, the present disclosure is adaptable such that touch sensor 801 may be coupled to PCH 807 by other interconnects such as, but not limited to, an embedded display port (eDP).

Although the present disclosure has been described herein as using a capacitive touch array to obtain touch input, the present disclosure is further adaptable to implement other touch input devices using different technologies such as light emitting cameras or other image-based touch or gesture capture techniques.

Moreover, other controllers such as a manageability engine (ME) or converged security engine (CSE). Such controllers execute firmware and have direct control over SPI 808 interface ports and associated direct memory access (DMA) 809 operations. In some embodiments, a dedicated microcontroller manages SPI 808 interface port and the associated DMA 809 or a dedicated state machine may be provided to control the SPI 808 interface port and DMA 809 operations (without use of a microcontroller).

Furthermore, the computer architecture 800 includes code to execute a touch algorithm 805 by execution units 806. In some embodiments, touch algorithm 805 includes code to initialize a touch application, receive an indication of touch data, identify a tip pattern from the received data, and execute a set of pre-determined instructions associated with the identified pattern. Touch algorithm 805 may further include code to identify a tip pattern by clustering raw touch data into a blob, employing pattern matching, and mapping the blob to one of a set of known blobs. Further, touch algorithm 805 may include code to measure a maximum pixel value of the touch data, measure the area of the blob, and measure a maximum slope of the blob.

In some implementations, the known tip patterns are characterized in relation to attributes of a particular feature set. More specifically, each know tip pattern may have a specific value (or range) for each attribute (e.g., maximum pixel value, blog area, maximum blob slope). As such, the attributes associated with the received touch data may be compared to that of known tip patterns thereby employing pattern matching to map the blob to one of a set of known blobs.

Touch algorithm 805 may also include code to send a message which includes the identified tip pattern to an operating system to execute the set of pre-determined instructions. In some embodiments, touch algorithm 805 implements blocks 703-710 of touch processing pipeline 700 from FIG. 7 by vendor kernels whereas blocks 701-702 of touch processing pipeline 700 from FIG. 7 are implemented by Intel® kernels. After touch algorithm 805 is completed, the processed touch data may be sent to a human interface device (HID) driver.

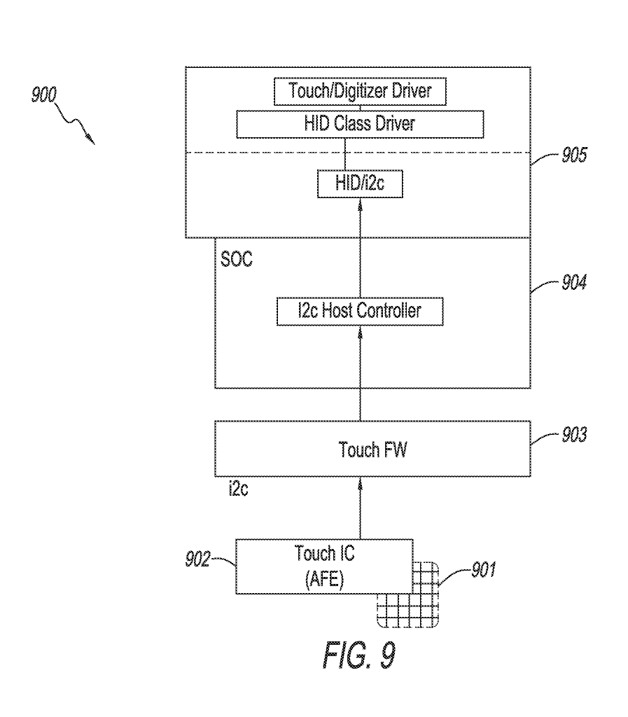

FIG. 9 is yet another exemplary layout of a computer architecture 900 which is operable to process touch-screen inputs with a passive stylus consistent with the present disclosure. Computer architecture 900 may be a representation of a touch-input device that does not implement Intel's® Integrated Touch technology. Computer architecture 900 includes a touch sensor device 901 (with analog frontend circuitry 902 therein).

In addition, computer architecture 900 may employ touch firmware (FW) 903 to implement a touch algorithm as described herein. Once the touch data is processed, commands and data may be sent to System-On-Chip (SoC) 904 and driver block 905. After the touch data is processed, a message is sent to the operating system to execute a set of pre-determined instructions associated with a detected tip pattern.

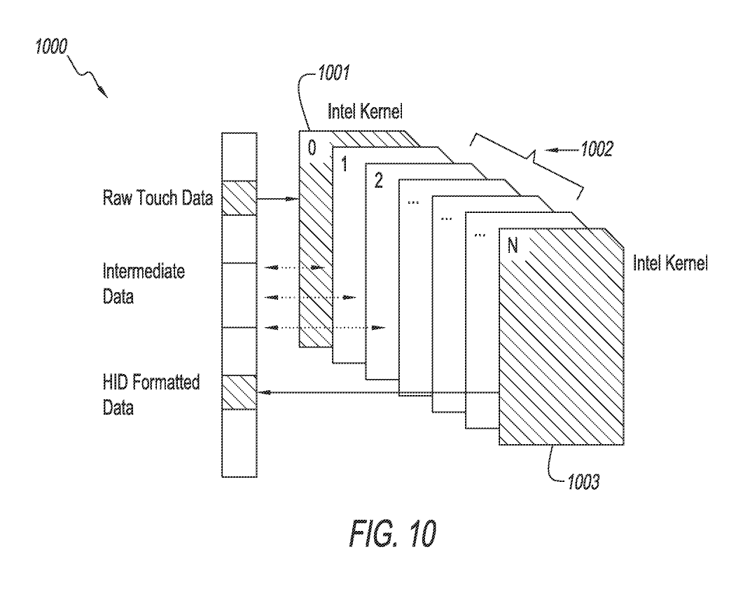

FIG. 10 is an illustration of a layout of proprietary and vendor kernels 1001, 1002, 1003 and the processing of touch data within a touch processing pipeline. In some embodiments, proprietary kernels 1001, 1003 are Intel® kernels (0, N) which may be used to pre-process and post process touch data. In some implementations, during pre-processing, the received raw touch data is logged (e.g., size and number of frames) and during post processing, the output may be translated for additional functionality.

For example, in the embodiment where an Intel® kernel is employed, the kernel receives touch output of processed touch data from a vendor kernel 1002. The processed touch data received from the vendor kernel 1002 may include a summary and other attributes of the processed raw touch data. In the event that a certain attribute is associated with the touch data, the vendor kernel 1002 sends a message to the operating system to take a specific action (e.g., display some prompt on the display, etc.). It should be understood however that both pre-processing and post processing are optional and that the present disclosure is not limited thereto.

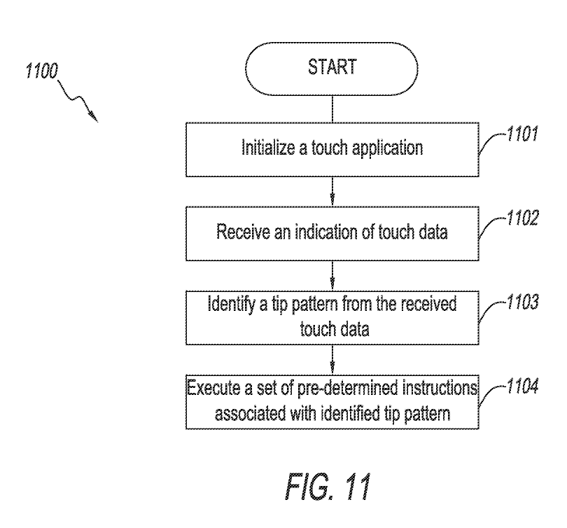

FIG. 11 is a flowchart 1100 of a method of processing touch data consistent with an embodiment of the present disclosure. Flowchart 1100 begins with block 1101 —initialize a touch application. A touch application may be initiated when a user touches a touchscreen component of a touch-input device with a passive stylus. After the touch application is initiated, (raw) touch data is received (block 1102) by a touch-input device. Next, identify a tip pattern from the received touch data (block 1103). The tip pattern may be associated with a blob cluster, which may be mapped to a nearest matched pattern. Further, execute a set of pre-determined instructions associated with an identified tip pattern (block 1104).

The present disclosure provides a description of a novel, multi-faceted passive stylus. It will be understood by those having ordinary skill in the art that the present disclosure may be embodied in other specific forms without departing from the spirit and scope of the disclosure disclosed. In addition, the examples and embodiments described herein are in all respects illustrative and not restrictive. Those skilled in the art of the present disclosure will recognize that other embodiments using the concepts described herein are also possible.

1. A passive stylus, comprising:
a shaft having a first end and a second end; and
a first nib at the first end and a second nib at the second end;
wherein the first nib and the second nib are different.

2. The passive stylus of claim 1, wherein at least one of the first nib and the second nib includes at least one of a round-shaped nib and a rectangular-shaped nib.

3. The passive stylus of claim 1, wherein at least one of the first nib and the second nib is to form at least one of a sharp-tip capacitive image, dull-tip capacitive image, and flattened-tip capacitive image on a touch-input device.

4. The passive stylus of claim 1, wherein the passive stylus is electronic-circuitry free.

5. A passive stylus, comprising:
a shaft having a first end and a second end;
wherein the shaft houses a plurality of rods, each having a unique nib at one end.

6. The passive stylus of claim 5, wherein the nib of each rod has a shape to form a sharp-tip capacitive image, dull-tip capacitive image, or flattened-tip capacitive image on a touch-input device.

7. The passive stylus of claim 5 further comprising a nib disposed on the second end of the shaft.

8. The passive stylus of claim 5 further comprising a mechanical push-down slider to expose one of the rods coupled thereto beyond the second end of the shaft.

9. The passive stylus of claim 5, wherein the plurality of rods include three rods housed within the shaft.

10. A system, comprising:
a dual-nibbed passive stylus, comprising:
a first end and a second end;
wherein the first end includes a first nib and the second end includes a second nib; and
a touch-input device adaptable to receive input from both ends of the dual-nibbed passive stylus.

11. The system of claim 10, wherein the touch-input device includes at least one of a smartphone, computing tablet, notebook computer, sub-notebook computer, ultraportable notebook computer, mini-notebook computer, netbook computer, ultrabook computer, or laptop computer.

12. The system of claim 10, wherein the first nib is round shaped and the second nib is rectangular shaped.

13. A computer readable medium including code, when executed, to cause a machine to:
initialize a touch application;
receive an indication of touch data;
identify a tip pattern from the received touch data; and
execute a set of pre-determined instructions associated with the identified tip pattern.

14. The computer readable medium of claim 13 further comprising code, when executed, to cause a machine to:
send a message, which includes a description of the identified tip pattern, to an operating system to execute the set of predetermined instructions.

15. The computer readable medium of claim 14, wherein the message includes the set of pre-determined instructions.

16. The computer readable medium of claim 13 further comprising code, when executed, to cause a machine to pre-process the touch data prior to identifying the tip pattern from the touch data.

17. The computer readable medium of claim 13 further comprising code, when executed, to cause a machine to:
post process touch output data before a message is sent to an operating system to execute the set of pre-determined instructions;
wherein the touch output data includes a description of at least one attribute of the received touch data.

18. A method, comprising:
initializing a touch application;
receiving an indication of touch data;
identifying a tip pattern from the received touch data; and
executing a set of pre-determined instructions associated with the identified tip pattern.

19. The method of claim 18, wherein receiving the indication of touch data includes receiving at least one of a sharp-tip capacitive image, dull-tip capacitive image, or flattened-tip capacitive image on a touch-input device.

20. The method of claim 19, wherein receiving at least one of the sharp-tip capacitive image, dull-tip capacitive image, or flattened-tip capacitive image initiates an eraser mode.

21. The method of claim 18, wherein identifying the tip pattern includes clustering the touch data into a blob, employing pattern matching, and mapping the blob to one of a set of known blobs.

22. The method of claim 18, wherein identifying the tip pattern includes identifying a tip pattern from a set of known tip patterns by measuring a maximum pixel value, a blob area of the tip pattern, and a maximum slope of the blob.

23. The method of claim 22, wherein the known tip patterns correlate to attributes of a feature set.

24. A touch-input device, comprising:
a processing unit communicatively coupled to memory;
wherein the memory is to store code that identifies a tip pattern from a set of known tip patterns associated with touch data.

25. The touch-input device of claim 24 further comprising a touch ASIC that receives an indication of the touch data.

26. The touch-input device of claim 24, wherein the processing unit includes a central processing unit.

27. The touch-input device of claim 24, wherein the processing unit includes a graphics processing unit.

28. The touch-input device of claim 24, wherein the memory includes code to execute a set of pre-determined instructions associated with the identified tip pattern.
